(19) United States
(12) Patent Application Publication
(10) Pub. No.: US 2011/0091735 A1
(43) Pub. Date: Apr. 21, 2011

(54) Manufacturing Process for a Laminated Structure

(76) Inventors: Potvin Luc, St-Lambert (CA); Pierre Levesque, Cte Matane (CA); Richard Lépine, Apex, NC (US)

(21) Appl. No.: 12/936,091

(22) PCT Filed: May 8, 2009
(86) PCT No.: PCT/CA09/00646

§ 371 Date: Dec. 17, 2010

Related U.S. Application Data
(60) Provisional application No. 61/051,374, filed on May 8, 2008.

(51) Int. Cl. B32B 21/06; B32B 29/06; B32B 37/12; B32B 37/16; B32B 38/14

(52) U.S. Cl. 428/535; 156/60; 156/306.6; 156/278

(57) ABSTRACT

There is provided a method of manufacturing an impact resistant laminated structure which comprises a support board, an adhesive and a decor paper. The method comprises introducing, in a short cycle press, the support board, the adhesive, and the decor paper, and consolidating them in a single step. A novel impact resistant laminated structure is also disclosed.

### FIELD OF THE INVENTION

The present invention generally relates to the field of transformed wood-based materials. More specifically, the invention relates to an impact resistant laminated structure having a wood-based support board.

### BACKGROUND OF THE INVENTION

Laminated panels such as melamine, foils or High Pressure Laminates (HPL) are used in the manufacture of cabinetry (such as kitchen cabinetry, bathroom cabinetry, store fixture etc) and various items of home and office furniture. For example, they can be used in the manufacture of countertops. Laminated panels offer an appealing solution to the cost conscious buyer while providing good impact resistance. Laminated panels are as well available in a multitude of finishes and colors, which makes them an attractive choice.

Such laminated panel structures are typically manufactured in three steps: a High Pressure Laminate (HPL) is manufactured in a first operation. The HPL is usually prepared using a multiopening high pressure press which is costly to operate. The High Pressure Laminate is a thermoset paper/adhesive composite having decorative papers impregnated with a melamine resin consolidated over backing sheets made of phenolic resin-impregnated kraft papers or dry process using an overlay followed by the decor paper and the phenolic backer. The consolidation occurs at high temperature and high pressure to form a homogeneous laminate. In a second operation, typically carried out by a different manufacturer, a support board is made that will form the base of the desired laminated structure. Then, in a third operation typically carried out by yet another manufacturer, the impact resistant laminated structure is made by bonding with an adhesive the HPL manufactured in the first operation over the support board manufactured in the second operation.

This is a lengthy process and there is much handling, transformation and transportation of materials, which does not add any value to the end product and increase the cost. Furthermore, the manufacturing process of the HPL alone is very lengthy and labor intensive. Indeed, the impregnated decorative papers and backing sheets need to be heated and then cooled under pressure, otherwise the HPL will warp due to internal stress occurring during cooling of the resins. Because of thermal inertia of the press and of the laminates themselves, this manufacturing cycle takes over one hour to produce a press load of HPL consisting of many HPL sheets. Although it is possible to simultaneously consolidate more than one sheet of HPL in the same press, it is nevertheless a lengthy process.

There is therefore a clear need for an improved manufacturing process for impact resistant laminated panel structures that will reduce the cost by reducing the manufacturing cycle time, labor and/or material transportation.

### SUMMARY OF THE INVENTION

It is an object of the present invention to provide a manufacturing process for impact resistant laminated structures that overcomes or mitigates one or more disadvantages of known manufacturing processes for such laminated structures, or at least provides a useful alternative.

In accordance with an aspect of the present invention, there is provided a method of manufacturing an impact resistant laminated structure having a support board, an adhesive and a decor paper. The method comprises introducing, in a short cycle press, the support board, the adhesive, and the decor paper, and consolidating them in a single step.

It has been found that such a method allows for the production of impact resistant laminated structures rapidly, in a single step and by using a low pressure press (i.e. a short cycle press). Such a method can produce laminated structures which have impact resistance and other properties similar to high pressure laminate material (HPL glued to a support board) but at a cost considerably lower since they are prepared in a single step and the capital cost and cycle time of a short cycle press is considerably lower than a high pressure press used for preparing the HPL. The prior art techniques also necessitate three steps. It was also found that such a method permits to obtain structures that meet the requirements of NEMA LD3 performance standardized test method for the VGL grade.

In accordance with another aspect of the present invention, there is provided a method of making an impact resistant laminated structure. The method comprises the step of consolidating by pressing together a support board, an adhesive and a decor paper. Consolidation occurs at a predetermined pressure, a predetermined temperature and during a predetermined time.

It has been found that such a method permits to overcome several of the drawbacks encountered in the prior art. In fact, such a method can permit to obtain, in a single step, an impact resistant laminated structures as opposed to the three steps required in the prior art to produce a structure that has similar properties. Such a method can be carried out by using a short cycle press or a HPL continuous press, which can be used in similar conditions.

According to another aspect of the present invention, there is provided an impact resistant laminated structure comprising:

a decor paper optionally comprising aluminium oxide thereon;

a kraft paper impregnated with at least one resin;

a support board; and

optionally a backing sheet.

The expression “short cycle press” as used herein refers to a heated press capable of applying determined pressure to a flat surface to polymerise together the different layers used in order to obtain a single product. Such as short cycle press is usually made with a single opening and uses lower pressures than HPL presses.

The expression “impact resistance laminated structure” as used herein refers to a laminated structure that meets the requirements the NEMA LD3 performance standardized test method for the VGL grade and others.

### BRIEF DESCRIPTION OF DRAWINGS

These and other features of the present invention will become more apparent from the following description in which reference is made to the appended drawings wherein:

FIG. 1 is an exploded schematic isometric view of the various components of a laminated structure ready to be consolidated by a pressure in the direction of the arrows, in accordance with an embodiment of the present invention; and

FIG. 2 is an exploded schematic isometric view of the various components of a laminated structure ready to be consolidated by a pressure in the direction of the arrows, in accordance with another embodiment of the present invention.

### DETAILED DESCRIPTION OF THE INVENTION

The present invention relates to a manufacturing process for a laminated structure. Although they may have many applications, these types of laminated structures are well known for their use as countertops, store fixtures and in the manufacture of cabinetry (such as kitchen cabinetry, bathroom cabinetry, etc), and home and office furniture etc. The person skilled in the art will recognize that many other applications for such a laminated structure are known and consequently the present invention is applicable to all of them.

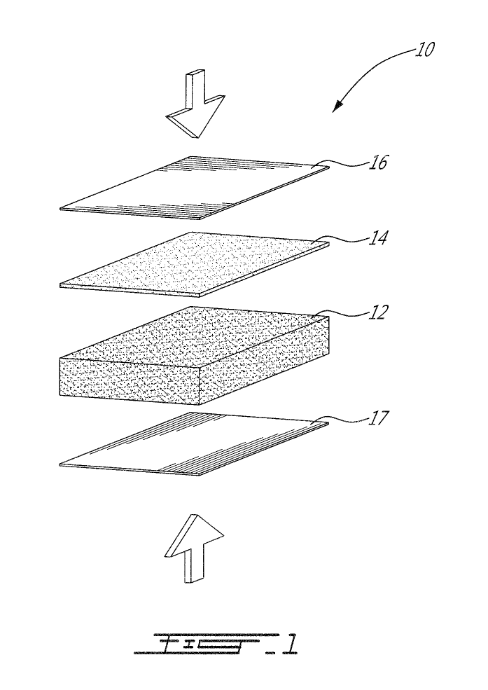

FIG. 1 depicts an exploded view of the various components of a laminated structure 10, prior to consolidation. The structure 10 can be composed of a support board 12, an adhesive (for example an adhesive sheet 14) and a decor paper 16, and optionally a backing sheet 17. The adhesive sheet can be an impact resistant adhesive sheet such as a kraft paper impregnated with a resin. The support board 12 can be made of a wood-based material such as medium density fiberboard (MDF), high density fiberboard (HDF), plywood, hardboard, or oriented strand board (OSB) or particle board. The adhesive sheet 14 is at least partially made of a resin. The adhesive sheet 14 may be un-reinforced, consisting essentially exclusively of resin, or it may be reinforced with a paper such as kraft paper that is impregnated with the resin. Reinforcing the adhesive sheet 14 with kraft paper increases the impact resistance of the laminated structure 10. Up to a certain level, adding more layers of kraft paper can further increase the impact resistance. The decor paper 16 can be raw, resin-starved, impregnated with a resin (such as melamine), impregnated with melamine and aluminium oxide. The decor paper can also be provided with an overlay. The overlay can comprise melamine, or melamine and aluminium oxide. The decor paper can be a Bullwark™ paper or a WRM™ paper for instance.

Thermoset resins require heat, or both heat and pressure, to cure. Phenolic resins have been known for a long time and are fairly low in cost, and may be used in the making the adhesive sheet 14. However, melamine resins have a lower molecular weight and are available in liquid form, which makes them useful for laminating or impregnating the kraft paper. Furthermore, melamine resins remain transparent when cured, which provides a better appearance when used to impregnate the decor paper than phenolic resins which appear brownish.

The decor paper 16 may be colored or it may be imprinted with an image such as a wood grain appearance, for example, to provide an attractive finish.

The backing sheet 17 is used for reinforcing the laminated structure 10 so that the laminated structure stays straight and does not induce over warping. It can be made of the same constituents that the adhesive sheet 14. The backing sheet 17 can also be of a different nature than the adhesive sheet 14. The backing sheet 17 can be made of various wood-based or fiber-containing products, as well as papers, etc. It can also be made of a recycled material such as recycled paper, recycled wood-based or fiber-containing products, etc. Recycled decor paper can also be used. The material used for the backing sheet can be impregnated with a resin. Alternatively, a glue or resin can be disposed between the backing sheet 17 and the support board 12.

The laminated structure 10 can be manufactured by consolidating the support board 12, the adhesive sheet 14, and the decor paper 16 under pressure with applied heat in a single operation. The adhesive sheet 14 is placed on a face of the support board 12 and the decor paper 16 is then placed over the adhesive sheet 14. This sandwich structure is placed in an open press where a consolidation process heats up the resin of the adhesive sheet 14, which adheres to both the support board 12 and the decor paper 16 under pressure. When the optional backing sheet 17 is added, the same procedure is used with the exception that the support board 12 is previously placed on the backing sheet 17 before receiving, on the other face, the adhesive sheet 14. The heat, typically provided by plates of the press, completes the curing of the resin of the adhesive sheet 14. As previously indicated, an adhesive sheet can optionally be consolidated with the other components of the structure 10 so as to reinforce it.

The consolidation process occurs at a predetermined pressure, a predetermined temperature and during a predetermined time. Typically, the pressure ranges from 1 MPa to about 4 MPa and the temperature ranges from 100° C. to 200° C. depending on the type of resin, or resins, used in the laminate 10. It has been found that the consolidating cycle may be much shorter than is required to make HPL, typically less than 1 minute. In fact, it has been found that the cycle time may be as short as approximately 15 seconds. However, the required cycle time may be longer or shorter, depending on the type of resin, additives in the resin and the type of manufacturing equipment used.

It is also possible to use a decor paper 16 that is pre-treated with resin. For instance, Bulwark™ decor paper, manufactured by Interprint, is supplied already with a thin layer of aluminium oxide on top of the paper before it is impregnated with melamine. This layer of aluminum oxide provides added wear resistance characteristics to the top surface of the laminated structure 10 once the decor paper 16 is bonded to it.

Unlike the manufacturing of HPL, where a lengthy complete cycle of heating and cooling must be performed under pressure to prevent warping of the HPL sheets, the consolidating process of the present invention does not require cooling while under pressure. This is particularly true when using a short cycle press, which can involve a hot pressing. Moreover, the added moment of inertia of the support board 12 provides a stiff laminate structure that resists warping. Nevertheless, in order to better equilibrate the laminate 10 and prevent unduly inducing internal stresses in the laminate 10, it is possible to better balance the laminate 10 when bonding at least one backing sheet 17 (or another decor paper sheet) to the support board 12 on its side opposite to the decor paper 16.

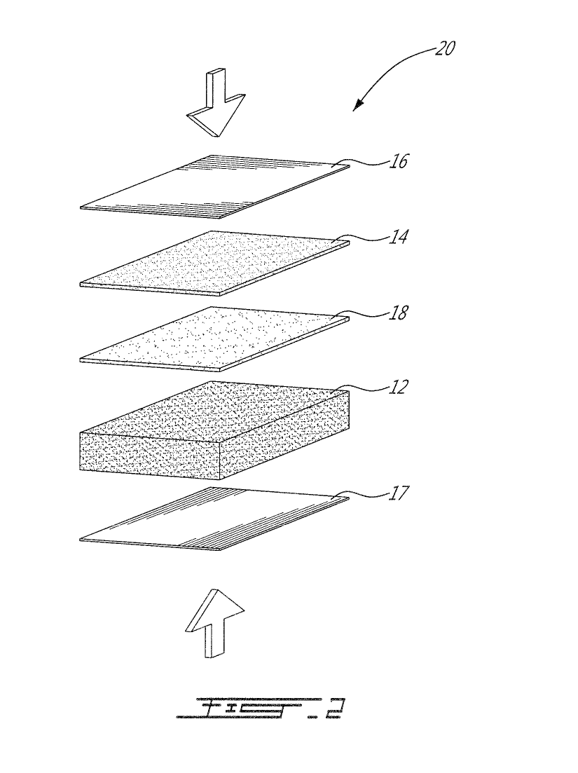

FIG. 2 depicts an exploded view of the various components of a laminated structure 20, prior to consolidation. FIG. 2 represents another embodiment of the present invention in which a dry glue sheet 18 is used to bond, under pressure and heat, the adhesive sheet 14 to the support board 12. In this case, the adhesive sheet 14 can consist essentially of at least one phenolic impregnated kraft paper in a cured or uncured resin, such as the phenolic resin provided in a cured state. The decor paper 16 may be in a raw state (no resin), starved (barely any resin) or dipped in the resin, such as melamine. It has been found that better results are obtained when the adhesive sheet 14 is slightly sanded, which provides an improved contact surface for the glue of the dry glue sheet 18 and also allows humidity to escape during heating under pressure. Again, the decor paper 16 may be coated with aluminum oxide if improved wear resistance is required. Alternatively, the decor paper 16 may be purchased with aluminum oxide particles already embedded in its resin. Again, in the present embodiment, the resins used are typically melamine and phenolic resins. Optionally, at least one backing sheet 17 may be bonded to the support board 12 on its side opposite to the decor paper 16 in order to lower internal stresses in the laminated structure 10. The process parameters such as temperature and pressure ranges and cycle time remain similar to those of the previous embodiment.

In the structures of the present invention, the impact resistance can be provided by the adhesive and/or the decor paper. As previously indicated, an adhesive sheet can be used (such as a kraft paper impregnated with a resin (uncured or semi-cured) or a cured resin) so as to provide the desired impact resistance. Alternatively, at least two layers or several layers of decor paper can be used so as to provide a sufficient impact resistance. Recycled or scrap decor paper can also be use to provide such supplemental layers.

The adhesive sheet can comprise a kraft paper impregnated with a resin. The resin can be in a semi-cured or uncured condition prior to the consolidation. The decor paper can be in a resin-starved condition prior to the consolidation or dry with an overlay or impregnated with a melamine solution

The adhesive sheet can comprise a kraft paper impregnated with a resin. The resin can be in a semi-cured or uncured condition prior to the consolidation. The decor paper can be of a resin-treated type.

The adhesive sheet can be a dry glue line.

The adhesive can also be in the form of sheet which consists essentially of a paper impregnated with a resin, and the consolidating step can further comprise laying a sheet of dry glue between the support board and the adhesive sheet. In such a case the decor paper can be in a resin-starved condition prior to consolidation. Alternatively, the adhesive can be in the form of a sheet which consists essentially of a resin, and the consolidating step can further comprise laying a sheet of dry glue between the support board and the adhesive. In such a case, the decor paper can be of a resin-treated type.

For example, the adhesive can comprise a sheet which consists essentially of a cured paper resin impregnated and a sheet of dry glue. The support board, the resin sheet, the dry glue sheet, and the decor paper can be successively disposed prior to consolidation.

The adhesive can also be in the form of sheet which consists essentially of a paper impregnated with a resin. The consolidating step can further comprise laying a sheet of dry glue between the support board and the adhesive sheet. In such a case, the decor paper can be of a resin-treated type.

The resin can comprise a phenolic resin, a melamine resin, a formaldehyde resin, an urea resin, a phenol-formaldehyde resin, a melamine-formaldehyde resin, a urea-melamine resin, an urea-formaldehyde resin, a phenol-melamine-formaldehyde resin, an urea-melamine-formaldehyde resin, a phenol-urea-formaldehyde, or mixtures thereof.

The decor paper can comprise aluminium oxide. The decor paper can be impregnated with at least one a resin chosen from a phenolic resin, a melamine resin, a formaldehyde resin, an urea resin, a phenol-formaldehyde resin, a melamine-formaldehyde resin, a urea-melamine resin, an urea-formaldehyde resin, an urea-melamine-formaldehyde resin, a phenol-melamine-formaldehyde resin, a phenol-urea-formaldehyde, or mixtures thereof. For example, the decor paper can be further impregnated with another resin chosen from a phenolic resin, a melamine resin, a formaldehyde resin, an urea resin, a phenol-formaldehyde resin, a melamine-formaldehyde resin, a urea-melamine resin, an urea-formaldehyde resin, an urea-melamine-formaldehyde resin, a phenol-melamine-formaldehyde resin, a phenol-urea-formaldehyde, or mixtures thereof.

For example, the decor paper, prior to consolidation, can be firstly impregnated with a urea-formaldehyde resin and secondly impregnated with a melamine-formaldehyde resin.

During consolidation, a backing sheet can also be consolidated with the support board, the adhesive, and the decor paper. In such a case, the backing sheet, the support board, the adhesive and the decor paper can be successively disposed prior to consolidation.

The decor paper can comprise a thin layer of aluminum oxide particles. Alternatively, the decor paper can comprise a raw paper having an aluminum oxide overlay thereon. The decor paper can also comprise aluminum oxide particles embedded in the resin of the decor paper.

The backing sheet can comprise various materials such a recycled materials. For example, the backing sheet can comprise a recycled decor paper.

Consolidation can be carried out at a temperature of about 100° C. to about 200° C., about 140° C. to about 180° C., about 150° C. to about 170° C., or about 165° C. Such temperatures refer, for example, to the temperature of both plates of the press. Consolidation can also be carried out at by applying a pressure of about 1 MPa to about 4 MPa, about 1.5 to about 3.5 MPa, about 2.6 MPa to about 3.2 MPa, about 2.8 MPa to about 3.0 MPa, or about 2.9 MPa.

For example, consolidation can be carried out over a period of time of less than 5 minutes, less than 2 minutes, less than 1 minute, less than 45 seconds, less than 30 seconds, or less than 20 seconds. For example, consolidation can be carried out over a period of time of about 10 seconds to about 40 second, about 15 seconds to about 35 seconds, or about 19 seconds to about 29 seconds.

The support board can be a wood-based board such as a particle board, a medium density fiber board, plywood, oriented strand board, hardboard or high density fiber board.

The impact resistant laminated structures can also be scratch resistant and wear resistant.

The impact resistant laminated structures can have a similar or better scratch resistance and wear resistance properties similar to an impact resistant high pressure laminate material as measured according to NEMA LD3 standard.

The impact resistant laminated structures can have similar properties than an impact resistant high pressure laminate material that meets the NEMA LD3 standards VGL grade or better.

The impact resistance laminated structures can have a NEMA LD3-3.8 ball impact resistance of at least 19 inches. The NEMA LD3-3.8 ball impact resistance of the structures can also be about 19 inches to about 21 inches.

The impact resistance laminated structures can have a NEMA LD3-3.13 wear resistance of more than 400 cycles. The NEMA LD3-3.13 wear resistance of the structures can also be about 450 cycles to about 500 cycles.

Without being bound to such a theory, it seems that the adhesive sheet (such as Kraft paper) provides impact resistance to the laminated structure, the support board provides rigidity, the optional backing sheet permits to balance and equilibrate the other face of the support board, and the decor paper provides the desired visual aspect to the laminate and the aluminum oxide provides scratch wear resistance to the laminated structure. The decor paper (for example Bullwark™ paper) can be supplied by Interprint™ and can be then impregnated by dipping it first into a UF resina, then dried, and dipped again in a MF resin.

In accordance with another aspect of the present invention, there is provided an impact resistant laminated structure which is made in accordance with any one of the methods as previously defined.

Tests have been carried out on an example of laminated structure according to the present invention.

Such a product so-called HPx by the applicants has been prepared as follows by consolidating, in a single step, in a short cycle press, (pressure of 2.9 MPa, temperature of about 165° C. (on both platen) during about 19 to about 29 second) the following constituents:

décor paper (including an aluminum oxide (alumina) layer or overlay on the upper face) impregnated with a one layer of a urea-formaldehyde resin (UF) and one layer melamine-formaldehyde resin (MF);

Kraft paper impregnated with a melamine-formaldehyde resin;

a support board such as a particleboard or a medium density fiberboard (MDF); and

a backing sheet such as a waste or recycled decor paper (same as the top layer).

The laminated structure so-obtained (HPx) was tested so as to verify if it meets the requirements of the NEMA LD3 standard for VGL. All the tests were done on a dark wood print color, a color for which it is difficult to reach an acceptable level of performance. The properties tested are as follow:

| Test method | Melamine | HPL -VGL grade | HPx Typical values |
|---|---|---|---|
| NEMA LD3-3.8 Ball | No requirement | Min = 15 inches | 19-21 inches |
| impact resistance | Typical value 12-16 | | |
| | inch | | |
| NEMA LD3-3.7 Scratch | 2.0-3.0N | Min = 1.75N | 3N |
| resistance | | | |
| NEMA LD3-3.13 Wear | 125 to 400 cycles | Min = 400 cycles | 450 to 500 cycles |
| resistance | | | |
| NEMA LD3-3.3 Light | Slight effect | Slight effect | No effect |
| resistance | | | |
| NEMA LD3-3.4 | <20 | Max 20 | 4 |
| Cleanability | | | |
| NEMA LD3-3.4 stain | 1-10 No effect | No effect | No effect |
| resistance | 11-15 Moderate | | |
| NEMA LD3-3.5 Boiling | No effect | Slight to no effect | No effect |
| water resistance | | | |
| NEMA LD3-3.6 High | Slight effect | Slight effect | N/A |
| resistance temperature | | | |

As it can be seen in the above table, the structures of the present invention meet the requirement of the NEMA LD3 standard for VGL. In fact, they have a higher wear resistance and a higher impact resistance than a regular melamine product.

The structures of the present invention are very promising products since their production is faster than the regular HPL production process. Moreover, the methods described in the present invention permit to manufacture the various structures of the invention, such as the HPx, and reach the HPL/VGL grade requirements using less handling, less paper, less time and less energy than the regular HPL production process. Thus, the methods of the present invention permit to save costs.

The present invention has been described with regard to preferred embodiments. The description as much as the drawings were intended to help the understanding of the invention, rather than to limit its scope. It will be apparent to one skilled in the art that various modifications may be made to the invention without departing from the scope of the invention as described herein, and such modifications are intended to be covered by the present description.

1. A method of manufacturing an impact resistant laminated structure which comprises a support board, an adhesive and a décor paper, said method comprising:
introducing, in a short cycle press, said support board, said adhesive, and said décor paper, and consolidating them in a single step.

2. A method of making an impact resistant laminated structure comprising:
consolidating by pressing together a support board, an adhesive and a décor paper on, said consolidating occurring at a predetermined pressure, a predetermined temperature and during a predetermined time.

3. The method of claim 1, wherein during said consolidation, a backing sheet is also consolidated with said support board, said adhesive, and said décor paper, and wherein said backing sheet, said support board, said adhesive and said décor paper are successively disposed prior to consolidation.

4-14. (canceled)

15. The method of claim 1, wherein said decor paper comprises aluminum oxide particles.

16-20. (canceled)

21. The method of claim 15, wherein said decor paper is impregnated with a urea-formaldehyde resin and with a melamine-formaldehyde resin.

22-27. (canceled)

28. The method of claim 1, wherein consolidation is carried out at a temperature of about 150° C. to about 170° C.

29. (canceled)

30. (canceled)

31. The method of claim 1, wherein consolidation is carried out at by applying a pressure of about 1.5 MPa to about 3.5 Mpa.

32. The method of claim 1, wherein consolidation is carried out at by applying a pressure of about 2.6 MPa to about 3.2 Mpa.

33-36. (canceled)

37. The method of claim 1, wherein consolidation is carried out over a period of time of less than 45 seconds.

38. (canceled)

39. (canceled)

40. The method of claim 32, wherein consolidation is carried out over a period of time of about 15 seconds to about 35 second.

41. (canceled)

42. The method of claim 1, wherein said support board is a wood-based board.

43-47. (canceled)

48. The method of claim 40, wherein the so-obtained laminated structure has similar properties than an impact resistant high pressure laminate material that meets the NEMA LD3 standards VGL grade or better.

49. (canceled)

50. (canceled)

51. The method of claim 1, wherein said structure has a NEMA LD3-3.8 ball impact resistance of at least 19 inches.

52. (canceled)

53. (canceled)

54. The method of claim 51, wherein said structure has a NEMA LD3-3.13 wear resistance of about 450 cycles to about 500 cycles.

55. (canceled)

56. An impact resistant laminated structure comprising:
a decor paper
a kraft paper impregnated with at least one resin;
a support board comprising a wood-based material; and
a backing sheet
wherein said decor paper comprises, thereabove, in the following order, aluminum oxide deposited thereon, and a resin layer deposited on said aluminum oxide.

57-64. (canceled)

65. The structure of claim 56, wherein said structure meets the requirements of the NEMA LD3 standard for VGL.

66. The structure of claim 56, wherein said structure has a NEMA LD3-3.8 ball impact resistance of at least 19 inches and wherein said structure has a NEMA LD3-3.13 wear resistance of about 450 cycles to about 500 cycles.

67. (canceled)

68. (canceled)

69. (canceled)

70. The structure of claim 56, wherein said backing sheet comprises a waste or recycled décor paper.

71. (canceled)

72. (canceled)

73. The method of claim 1, wherein said décor paper, prior to consolidation, is treated by applying aluminum oxide particles thereon and then by impregnating said décor paper having aluminum oxide particles thereon with at least one resin chosen from a phenolic resin, a melamine resin, a formaldehyde resin, an urea resin, a phenol-formaldehyde resin, a melamine-formaldehyde resin, a urea-melamine resin, an urea-formaldehyde resin, an urea-melamine-formaldehyde resin, a phenol-melamine-formaldehyde resin, a phenol-urea-formaldehyde, or mixtures thereof.

74. The method of claim 73, wherein said decor paper after being impregnated by said at least one resin is impregnated with at least one another resin chosen from a phenolic resin, a melamine resin, a formaldehyde resin, an urea resin, a phenol-formaldehyde resin, a melamine-formaldehyde resin, a urea-melamine resin, an urea-formaldehyde resin, an urea-melamine-formaldehyde resin, a phenol-melamine-formaldehyde resin, a phenol-urea-formaldehyde, or mixtures thereof.
